(19) United States
(12) Patent Application Publication
(10) Pub. No.: US 2002/0040657 A1
(43) Pub. Date: Apr. 11, 2002

(54) Pulsed linear induction motors for Maglev applications

(76) Inventor: Kent Davey, New Smyrna Beach, FL (US)

Correspondence Address: Levisohn, Lerner, Berger & Langsam, Suite 2400, 757 Third Avenue, New York, NY, 10017, US

(21) Appl. No.: 09/834,224

(22) Filed: Apr. 12, 2001

Related U.S. Application Data
(63) Continuation-in-part of application No. 09/507,165, filed on Feb. 18, 2000.
Application No. 09/507,165 is a continuation-in-part of application No. 08/493,332, filed on Jun. 23, 1995, now Pat. No. 6,044,770.
Application No. 08/493,332 is a continuation-in-part of application No. 08/169,484, filed on Dec. 17, 1993, now abandoned.
Application No. 08/169,484 is a continuation of application No. 07/835,156, filed on Feb. 12, 1992, now Pat. No. 5,605,100.
Application No. 07/835,156 is a continuation-in-part of application No. 07/601,109, filed on Oct. 23, 1990, now abandoned.

(51) Int. Cl. B60L 13/04

(52) U.S. Cl. 104/282; 104/281

(57) ABSTRACT

Conventional linear induction motors (LIMS) have been used effectively to get linear thrust. These devices are typically short stator, and thus have entry and exit field effects. When a field enters a coil, there is a braking, drag force. A pulsed linear induction motor (PLIM) pulses the coils so that they push off the secondary shorted coils. Among the advantages gained by the use of these devices is no entry drag effect, simpler electronics required to excite the PLIM, and a smaller winding overhang past the steel structure of the PLIM. This invention describes coil arrangements useful for exciting a continuous array of coils, placed end to end, and coils that are overlapped. Control is realized by selecting the number of pulses to apply during the active excitation window.

### RELATED APPLICATIONS

This application is a continuation-in-part of U.S. patent application Ser. No. 09/507,165 (pending), which is a continuation-in-part of patent application Ser. No. 08/493,332, filed Jun. 23, 1995 (now U.S. Pat. No. 6,044,770), which is a continuation-in-part of patent application Ser. No. 08/169,484, filed Dec. 17, 1993, which is a continuation of patent application Ser. No. 07/835,156 filed Feb. 12, 1992 (now U.S. Pat. No. 5,605,100), which is a continuation-in-part of patent application Ser. No. 07/601,109 filed Oct. 23, 1990.

### BACKGROUND OF THE INVENTION

1. Field of the Invention

This invention relates to pulsed linear induction motors (PLIM), and more specifically the use of PLIM in magnetic levitation vehicles. Description of the Related Art The concept of using PLIM in Maglev applications was introduced in June 1995 by Turman of Sandia National Laboratories[1], the teachings of which are fully incorporated by reference herein. The original idea was to employ a simple ladder mechanism as the secondary of an induction motor. The rungs of the ladder were composed of aluminum plates. Plate shaped primary coils were affixed to the vehicle as suggested in FIGS. 1A-C. Shown drawn are three positions of the vehicle coil translating past the ground based ladder rungs. At position A, the vehicle coil current is fired. It rises to a peak ideally when the coil half shadows the guideway plate at position B. Finally in position C it falls completely to zero and must remain off until the coil completely shadows the next guideway plate. The positions A-C is the active excitation window during which the current should be activated. FIG. 1D shows in graphical format the application of vehicle coil current I with respect to time t.

The specifications for the Sandia work were encouraging. The system was inverted, so the plate was moving and the coils were stationary. Sandia's PLIM was able to accelerate a 30 lb plate of aluminum down a 4 m track to a speed of 15 m/s. The force peak was 18 kN (4,048 lbs) per coilset. The weight of their 125 kW power supply was 86 lbs. These forces were produced using only a single plate. The inductance of the coil used was 3.74 mH, which is very small. A nominal period of 12 ms was employed.

The theory is that as the source current is increasing, an induced plate current is generated which tries to oppose the increase as sketched in the last plate in FIG. 1. Since unlike currents repel, the fixed guideway plate pushes the coil away from it, thus moving the vehicle forward. The rise and fall of the current must ideally be completed before the coil begins to shadow the next plate.

Every Maglev system has the problem of power transmission and power handling. Nearly every synchronous motor propulsion scheme keeps the power on the guideway[2], and inductively couples service power to the vehicle [3]. The short stator systems usually employ a linear induction motor, such as the Birmingham Airport, HSST in Japan[4], and the LIM project in Korea[5]. All require expensive power handling inverter equipment [6].

Maglev systems have the task of realizing lift, guidance, and propulsion. The guideway plates employed by Sandia are not suitable to these three functions, but isolated coils are felicitous. The use of a PLIM with such coils requires thought. The principle motivations driving this work and objects of the invention are as follows:

1. Reduce winding overhang.

2. Reduce power electronics.

3. Improve power factor.

### SUMMARY OF THE INVENTION

It is an object of this invention to improve on the PLIM work of Sandia. The improvement is realized through two means. First, it can be shown that replacing a simple rectangular coil with a null flux coil can be used to increase the efficiency of the thrust force production. Such coils can be used in tandem to operate on the same guideway coil or plate circuit. Further, such PLIM coils can be used effectively on overlapped guideway coils. Also, by exciting the PLIM coils with current pulses shorter than the active duration, control options surface wherein the thrust force will be controlled by the number of pulses fired.

### BRIEF DESCRIPTION OF THE DRAWINGS

FIGS. 1A-C are a series of schematics of a conventional coil design.

FIG. 1D is a graphical depiction of the application of vehicle coil current with respect to time in the prior art coil design of FIGS. 1A-C.

FIG. 2A is a side view schematic of a practical exciting coil to be used with a PLIM system composed of a figure “8” shaped coil around a tape wound core in accordance with the invention.

FIG. 2B is a perspective view schematic of the practical exciting coil of FIG. 2A.

FIG. 3 is a schematic of null flux PLIM coils with continuous guideway coils in accordance with the invention.

FIG. 4 is a schematic of PLIM excitation coils placed side by side and excited as shown for a system of overlapped guideway coils, in accordance with the invention.

FIG. 5 is a circuit diagram depicting the preferred circuit used to excite the PLIM coils of the present invention.

FIG. 6 is a graph depicting computed force as a function of normalized position for one PLIM excitation pair.

FIG. 7 is a graph depicting change in force as the circuit frequency (# pulses) is increased.

FIG. 8 is a graph depicting force versus position using 20 pulses per window.

FIG. 9A is a schematic representing a single guideway coil moving past a rectangular vehicle coil.

FIG. 9B is a schematic showing a single null flux vehicle coil of FIG. 3 moving past multiple guideway coils.

FIG. 10 is a graph showing a comparison of average forces of half wave short pulses and full wave signals.

### DETAILED DESCRIPTION OF THE PREFERRED EMBODIMENTS

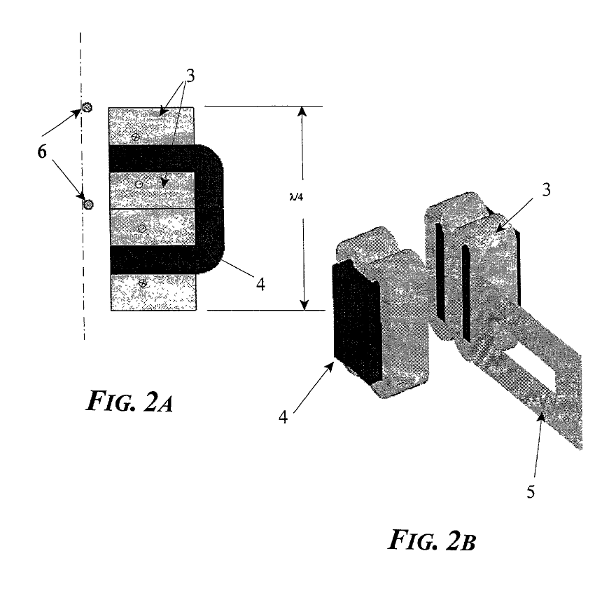

Description of the invention will now be provided with reference to exemplary FIGS. 2-10. These figures do not in any way limit the scope of the invention, which is defined by the claims attached hereto.

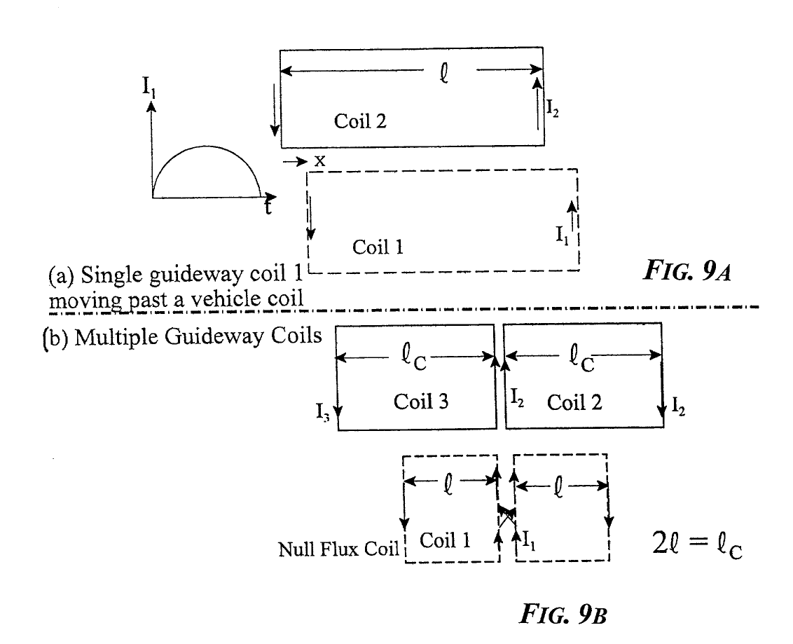

Shown in FIG. 9A is a single rectangular coil 1 moving past its stationary ground based mate. To a close approximation, the mutual inductance coupling between the two coils can be represented as

M=M₀ cos(kx) (1)

where the wave number k=2π/(4l). Although the current is merely a function of time, it is convenient to think of its representation at a point in space, linking x and t as x=vt. Current is constrained to begin rising in coil 1 sinusoidally as

$$\begin{matrix}{I}_{1} = {I}_{0} sin ( 2 kx ) = {I}_{0} sin ( \frac{π}{l} x ) \\ = {I}_{0} sin ( 2 kvt ) = {I}_{0} sin ( ω t )\end{matrix} \qquad ( 2 )$$

The guideway coil 2 has a self inductance L and resistance R. The current in this shorted coil will be governed by

$$L \frac{ⅆ {I}_{2}}{ⅆ t} + {RI}_{2} + \frac{ⅆ ( {MI}_{1} )}{ⅆ t} = 0 \qquad ( 3 )$$

The frequency q is maintained high enough to keep the current in an inductance limited regime, in which LdI₂/dt>>RI₂. Thus the current in coil 2 is

$${I}_{2} = - \frac{{M}_{0} {I}_{0}}{L} cos ( \frac{ω}{2} t ) sin ( ω t ) = - \frac{{M}_{0} {I}_{0}}{L} cos ( kx ) sin ( 2 kx ) \qquad ( 4 )$$

The coenergy of this two coil systems is

W′=M₀ cos(kx)I₁I₂ (5)

The x directed force on the vehicle coil 1 is

$$\begin{matrix}{F}_{x} = \frac{ⅆ W}{ⅆ x} = - {I}_{1} {I}_{2} {M}_{0} k sin ( kx ) \\ = \frac{{( {M}_{0} {I}_{0} )}^{2} k}{L} sin ( kx ) cos ( kx ) {sin}^{2} ( 2 kx )\end{matrix} \qquad ( 6 )$$

Of particular interest is the average force <Fx>,

$$\begin{matrix}⟨ {F}_{x} ⟩ = \frac{1}{l} {\int }_{0}^{l} \frac{{( {M}_{0} {I}_{0} )}^{2} k}{2 L} {sin}^{3} ( 2 kx ) ⅆ x \\ = \frac{{( {M}_{0} {I}_{0} )}^{2}}{lL} [ \frac{1}{3} ]\end{matrix} \qquad ( 7 )$$

The montage presented thus far is impractical. It is desirable for the propulsion current pulse to come from a capacitor discharging in resonance with the vehicle coil. Since it is not practical to carry multiple capacitors, the time constant τ (where τ=2π\sqrt{LC}) of the pulse must be chosen sufficiently short. In fact it must be chosen so that a half wave occurs over the distance l, so that τ=2l/v. Consider the half wave pulse to be centered on the fixed coil 2 so that

$${I}_{1} = {I}_{0} sin [ \frac{π}{2 Δ } ( x - ( \frac{l}{2} - Δ ) ) ] \qquad ( 8 )$$

With the vehicle traveling at velocity v, the pulse would be initiated at x=l/2−vτ/4, so that Δ=vτ/4. Consistent with the assumption that excitation frequencies are maintained in the inductance limited regime would be a coil 2 induced current

$$\begin{matrix}{I}_{2} = - \frac{{MI}_{i}}{L} \\ = - \frac{{M}_{0} {I}_{0}}{L} cos ( kx ) sin [ \frac{π}{2 Δ} ( x - ( \frac{l}{2} - Δ ) ) ]\end{matrix} \qquad ( 9 )$$

In this context, it is understood that l/2−Δ<x<l/2+Δ. The coenergy W′ and force are determined as before, and yield the result,

$$\begin{matrix}{F}_{x} = \frac{ⅆ {W}^{′}}{ⅆ x} \\ = - \frac{{( {M}_{0} {I}_{0} )}^{2} k}{2 L} sin ( 2 kx ) {sin}^{2} [ \frac{π}{2 Δ} ( x - ( \frac{l}{2} - Δ ) ) ]\end{matrix} \qquad ( 10 )$$

The key parameter to be compared to (7) is the average force <Fx>,

$$\begin{matrix}⟨ {F}_{x} ⟩ = \frac{1}{2 Δ} {\int }_{\frac{l}{2} - Δ}^{\frac{l}{2} + Δ} F ( x ) ⅆ x \\ = \frac{{( {M}_{0} {I}_{0} )}^{2}}{lL} [ \frac{\frac{1}{8} sin ( \frac{πΔ}{l} )}{\frac{Δ}{l} ( 1 - {( \frac{Δ}{l} )}^{2} )} ]\end{matrix} \qquad ( 11 )$$

The two bracketed terms in(7) and (11) are to be compared; their ratio dictates the loss realized through the use of a full wave current signal versus that of the half wave. This comparison follows after an examination of the full wave excitation.

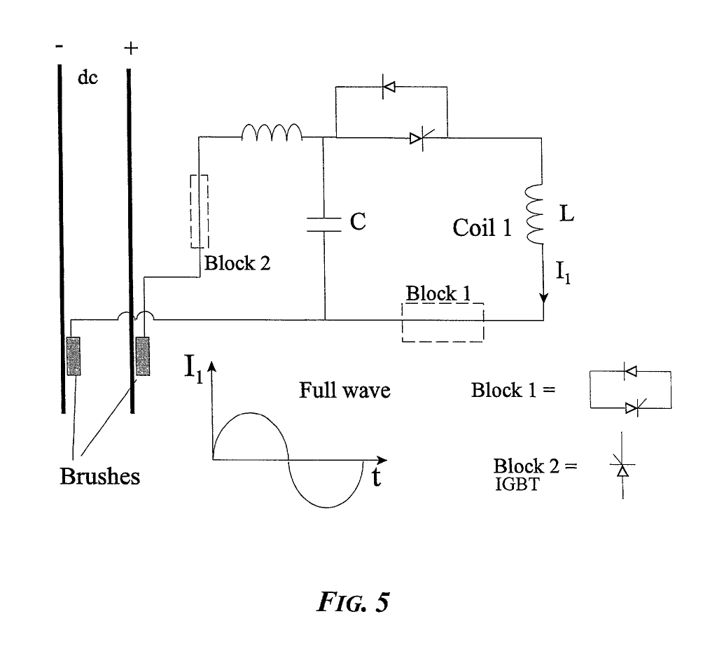

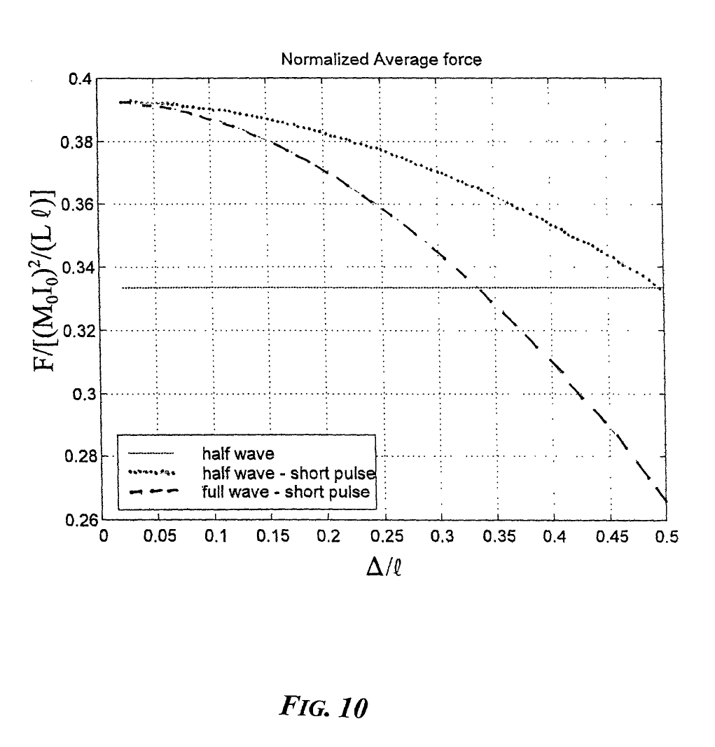

The two cases examined assumed that the excitation current was a half sine wave. Such an excitation poses many problems. It is desirable to continuously charge the capacitors directly from whatever dc voltage is on the rails. It is highly desirable that the pulse circuit be simple; the favored pulse circuit is that shown in FIG. 5. The full wave current pulse will be delivered when the thyristor is fired. A circuit delivering a half wave pulse would require at minimum another thyristor-diode pair in block 1 to control the backfire, and a thyristor in block 2 to shut off the charging when the capacitor is reverse charged, as suggested in the inset of FIG. 10. It is envisioned that one firing unit be placed on every coil. The natural question to be asked is “what price is payed if the current is a full wave and these expenses are eliminated?” To perform this simulation, the current in coil 1 is assumed to carry the full wave current, and is always to be centered on the coil's midpoint, l/2. FIG. 10 shows a comparison of average forces of half wave short pulses and full wave signals.

$${I}_{1} = {I}_{0} sin [ \frac{π}{Δ} ( x - ( \frac{l}{2} - Δ ) ) ] \qquad ( 12 )$$

As with the previous example, its width (2Δ) will be less than coil's width l . The coil's resonant frequency will be chosen so that 2Δ=l at the highest vehicle speed. At all lower speeds, Δ<l/2. Assuming the time constant of the LC circuit in FIG. 5 is τ, when the vehicle is traveling at velocity v, the thyristor would be fired at a position x=l/2−vτ/2. The base mutual inductance continues to be represented by (1). Coil current I₂, instantaneous force, and average force follow as

$$\begin{matrix}{I}_{2} = - \frac{{MI}_{1}}{L} = - \frac{{M}_{0} {I}_{0}}{L} cos ( k x ) sin [ \frac{π}{Δ} ( x - ( \frac{l}{2} - Δ ) ) ] & ( 13 ) \\ \begin{matrix}{F}_{x} = \frac{ⅆ {W}^{′}}{ⅆ x} = {I}_{1} {I}_{2} {M}_{0} k cos ( k x ) \\ = - \frac{{( {M}_{0} {I}_{0} )}^{2} k}{2 L} sin ( 2 k x ) {sin}^{2} [ \frac{π}{Δ} ( x - ( \frac{l}{2} - Δ ) ) ]\end{matrix} & ( 14 ) \\ ⟨ {F}_{x} ⟩ = \frac{1}{2 Δ} {\int }_{\frac{l}{2} - Δ}^{\frac{l}{2} + Δ} F ( x ) ⅆ x = \frac{{( {M}_{0} {I}_{0} )}^{2}}{l L} [ \frac{\frac{1}{8} sin ( \frac{π Δ}{l} )}{\frac{Δ}{l} ( 1 - {( \frac{Δ}{2 l} )}^{2} )} ] & ( 15 )\end{matrix}$$

The bracketed terms in (7), (11), and (15) represent the difference between the half wave-short time constant, and full wave-short time constant options. The results plotted in FIG. 10 reveal that the short pulse excitations yield a higher average force than the pulse that matches the coil length width. The shorter coil makes better use of the region where the mutual inductance is changing more rapidly.

The above propulsion system works only if the guideway coils are spaced a distance l apart. However, a practical Maglev system will attempt to use the same coils for lift and guidance. Intermittent spaced coils are a disadvantage for delivering lift at low speeds. Continuous coils guarantee a more manageable propulsion, lift, and the preferred embodiment of the invention is show as the guidance system. in FIG. 9B. FIG. 9B shows how to excite multiple guideway coils, the average forces being the same as equations (11) and (15). The resulting PLIM propulsion systems have the advantage of eliminating the entry and exit edge effects of a LIM system, and the excitation electronics are simpler.

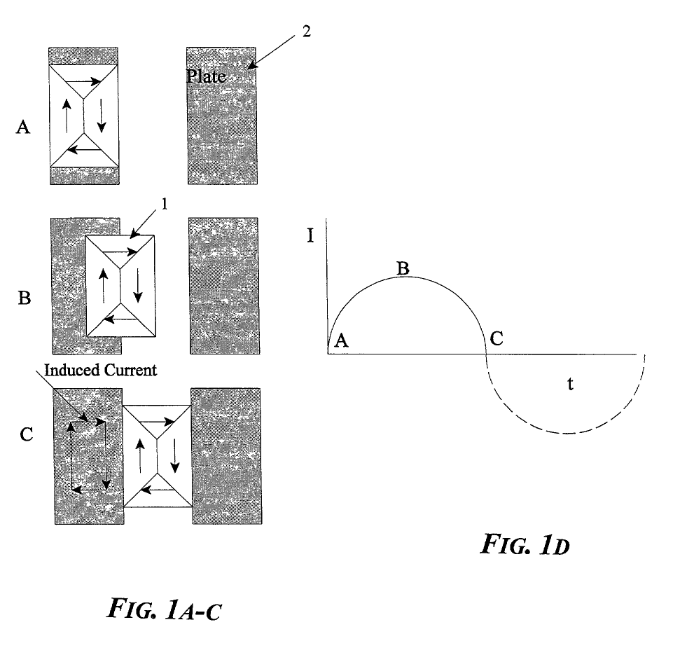

The preferred embodiment of the invention utilizes a PLIM to replace the exciting coil in FIG. 1 with a laminated or tape wound core 3 as shown in FIGS. 2A-B. The winding 3 of the PLIM is wound around laminated steel 4. When the guideway coils are overlapped and phase shifted, such coils are in reality placed side by side. One such guideway coil 5 is shown in the perspective inset for clarity. The shape of the iron was realized by examining the flux crossing the airgap midline through points 6. The shape shown is the unconstrained maximization of the index (flux²/weight).

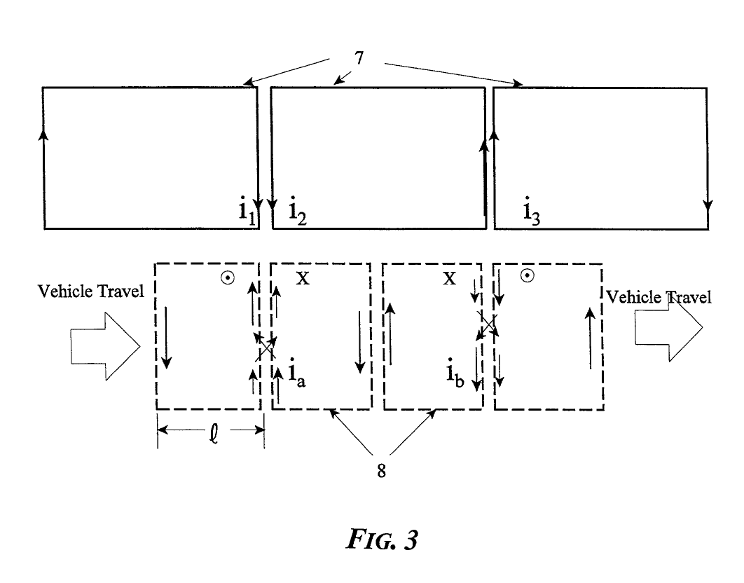

Shown in FIG. 3 is the preferred arrangement of PLIM coils 8 when the guideway coils 7 are continuous. The guideways coils can be discrete coils or sections of a ladder and rung arrangement. Each PLIM coil is arranged as a figure “8” null flux coil. The width of the null flux coil l should equal the half width of the guideway coil. When the center of the null flux PLIM coil 8 is centered over the edge of the guideway coils as depicted in FIG. 3, the active window begins. That active window ends when the center of the null flux PLIM coil reaches the middle of the guideway coil; only during the active window should current be activated into the PLIM coil. PLIM current should be off during the inactive window, which is the remainder of the travel distance until the center of the PLIM coil is centered over the edge of a guidance coil again. When continuous guideway coils are employed, null flux PLIM coils having a half width l of approximately half the guideway coil width will work together to give efficient thrust. Although the system is drawn as a linear topology, the system may also be designed with a cylindrical topology to provide circular motion. What follows works in either a linear or a cylindrical topology.

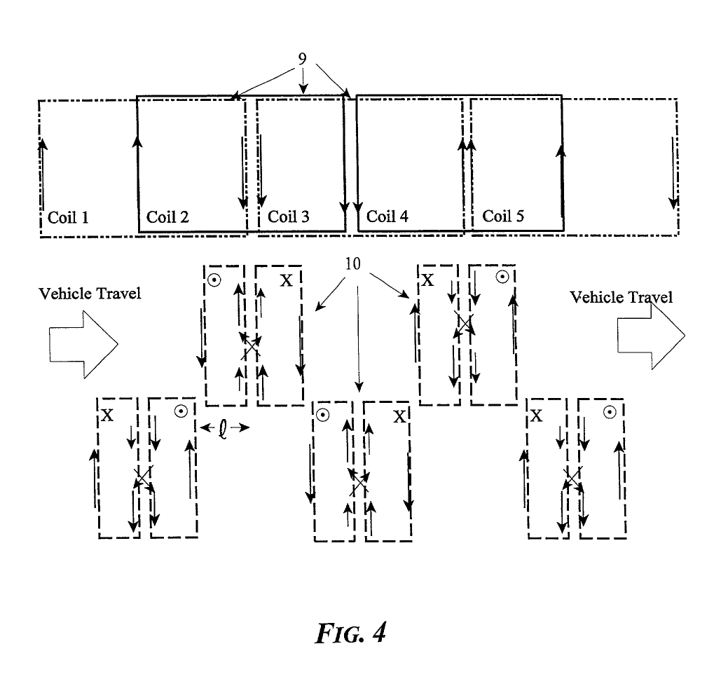

When the guideway coils are overlapped, the system still works, but the coils need to shrink. Shown in FIG. 4 is the correct PLIM excitation scheme when the overlapped guideways coils 9 are over lapped. Smaller adjacent PLIM coils 10 being null flux coils will link no net flux with the guideway coil of the adjacent PLIM coils. The half width of the PLIM coil l has shrunk to approximately half that shown in FIG. 3, or approximately one-quarter the width of a guideway coil. The PLIM coils are staggered vertically merely for clarity in presentation. In construction they are placed adjacent to one another at the same height as the guideway coils.

A typical firing circuit for the PLIM is accomplished through the discharge of a capacitor in resonance with the PLIM inductance as shown in FIG. 5. Using an Integrated Gate Controlled Thyristor (IGCT, a high voltage, high current silicon power semiconductor with an integrated turn-on/turn-off controller) or an Insulated Gate Bipolar Transistor (IGBT, a power semiconductor component used in power conversion devices which typically operates in the 300 to 6000 volt range and at switching frequencies up to 20,000 Hz) in block 2 blocks forward current during the discharge cycle of the capacitor. Block 1 can be employed to deliver only a half wave signal; the more practical excitation is to use a full wave excitation since the capacitor can continue to recharge immediately after completion of one cycle. If constant speed operation is desired, the capacitor can be selected so that one complete sinusoid just fills the active window. This is generally impractical since force is desired at different speeds. Thus, a better control strategy is to select a higher pulse frequency than is required even at the vehicle's highest speed, and fire multiple pulses during the active pulse window. Both full and half wave excitation is possible depending on whether Block 1 is employed. Best performance is obtained if an IGBT blocks forward current during the discharge cycle.

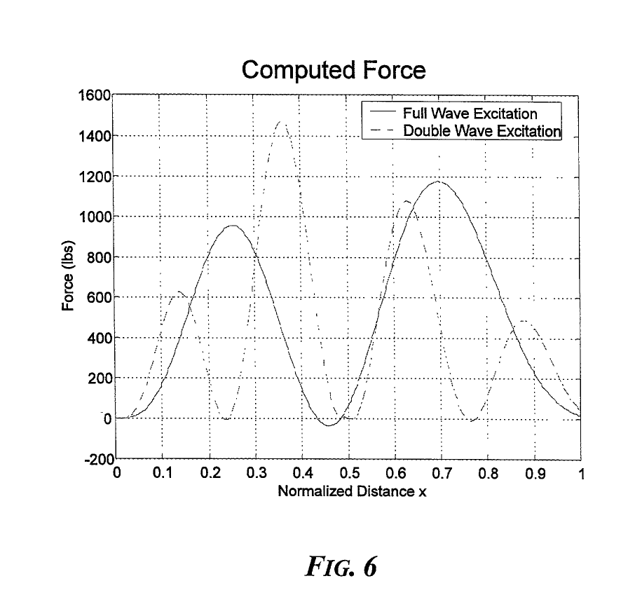

The force from a full wave excitation will have a double hump due to the oscillating nature of the current. Shown in FIG. 6 is a picture of the force versus normalized position\tilde{x} where \tilde{x}=x/l. Normalized position indicates how much of the vehicle coil shadows the guideway coil. Thus, when half of the vehicle coil shadows the guideway coil, we are at position \tilde{x}=0.5. This is the value one would use in the equations specified to get the voltage and current, and forces, etc. (The following properties come from a representative configuration and each of the inductances was computed numerically using boundary element software. They are merely representative and in no way serve to limit the scope of the invention.). The average force is 2.22 kN (499 lbs). If the amp-turns are dropped to their continuous rating of 13,972, the inductances increase due to lesser saturation to M=1.206 μH, Lₐ=5.338 μH, L₂=2.945 μH, C=424 μF, and Nₐ=40, where

M=mutual inductance between the guideway coils and the vehicle PLIM coil;

Coils 1,2,3 are the guideway coils shown in FIG. 4;

Lₐ is the self inductance of the vehicle coil;

L₂ is the self inductance of the 2nd guideway coil in FIG. 4;

C is the capacitance in FIG. 5.

Nₐ is the number of turns on the vehicle coil. Because of the higher mutual coupling, the force drops only to 1.78 kN (401 lbs). When the active window is excited at twice the frequency, the force changes to the dashed wave in FIG. 6, and the mean force drops to 1.96 kN (442 lbs).

As stated above, one inefficient way to control speed is to carry an array of capacitors on the vehicle and allow the time constant τ_{C} to vary so that a full wave of current fits into the active window of time τ_{S}=l/v. The more practical way to control speed is to select a fixed time constant 3-4 times the highest speed of travel. As suggested by FIG. 6, the force versus time will have consecutively more humps. Speed control would be achieved by choosing the number of pulses to fire during the active window.

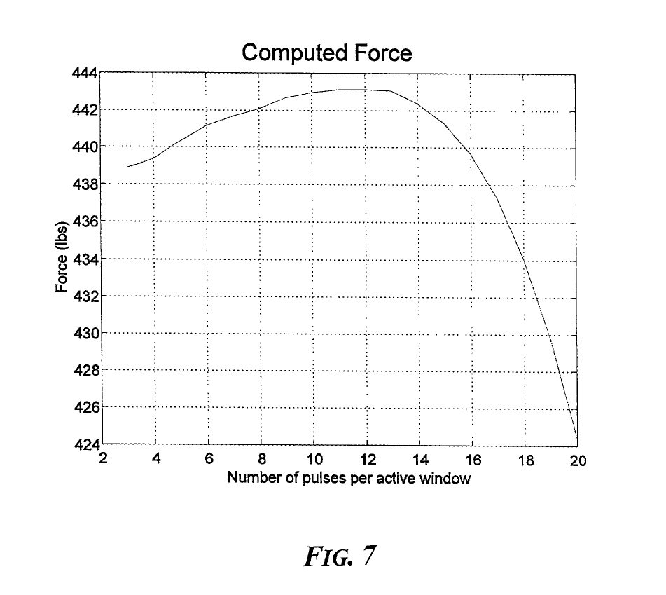

What price is paid to achieve this type of control? Shown in FIG. 7 is the change in force as a function of the number of pulses. The force remains rather stable over a range of frequencies.

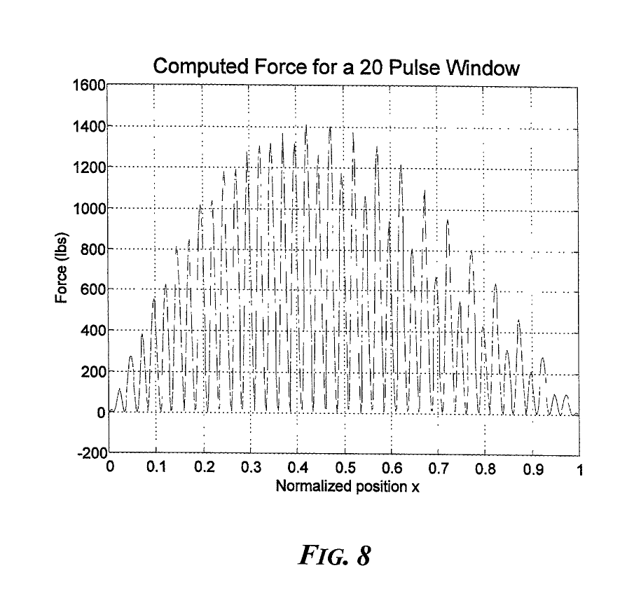

The first few pulses and the last few pulses contribute little to the force. Better force, and thus speed control, would be better realized by concentrating the pulses over the central position of the active window. Shown in FIG. 8 is the actual force versus normalized position\tilde{x} for a 20 pulse excitation, defending the thesis that clustering pulses over the central portion of the active window is a more efficient means of speed control. More of the energy is recaptured by the capacitor during the “inefficient” front and back end pulses, but the resistive dissipation energy is still lost.

Having described this invention with regard to specific embodiments, it is to be understood that the description is not meant as a limitation since further embodiments, modifications, and variations may be apparent or may suggest themselves to those skilled in the art. It is intended that the present application cover all such embodiments, modifications and variations and the scope of the invention be determined by the claims appearing hereinbelow.

The following references are referred to above, the contents of which are fully incorporated herein by reference:

1. B. N. Turman, B. M. Marder, G. J. Rohwein, D. P. Aeschliman, J. B. Kelley, M. Cowan, R. M. Zimmerman, “The Pulsed Linear Induction Motor Concept for High Speed Trains”, Sandia Report, SAND-1268, UC-1500, June 1995.

2. U. Henning, “Long Stator Propulsion System of the Transrapid Berlin-Hamburg”, 15^{th} International Conference on Magnetically Levitated Systems and Linear Drives—Maglev 98, Apr. 12-15, 1998, Mt Fuji, Japan, pp. 274-279.

3. M. Andriollo, G. Martenelli, A. Morini, A. Tortella, “Electromagnetic Optimization of EMS-Maglev Systems”, IEEE Trans. Magnetics, vol. 34, no. 4, July, 1998, pp. 2090-2092.

4. T. Seki, “The development of HSST-L”, 14^{th} International Maglev Conference, Bremen, Germany, November 1995, ISBN 3-8007-2155-4, pp. 51-55.

5. I. K. Kim, M. H. Yoo, K. H. Han, G. S. Park, H. S. Bae, “Status of the Maglev development in Korea”, 15^{th} International Conference on Magnetically Levitated Systems and Linear Drives—Maglev 98, Apr. 12-15, 1998, Mt Fuji, Japan, pp. 34-38.

6. J. Kitano, S. Yokoyama, “PWM Converter and Inverter System for Yamanashi Test Line”, 14^{th} International Maglev Conference, Bremen, Germany, November 1995, ISBN 3-8007-2155-4.

What is claimed is:

1. A magnetic linear propulsion system comprising:
a plurality of guideway coils disposed on a guideway;
at least one excitation PLIM coil in a null flux geometry disposed on a vehicle operating along said guideway in communication with said guideway coils; and
at least one excitation circuit, in electrical communication with said null flux excitation PLIM coil, forcing a plurality of pulses of current through said null flux excitation PLIM coil during each active excitation window.

2. A magnetic linear propulsion system according to claim 1, wherein said null flux excitation PLIM coil has a first half-width and said guideway coil has a second width, said first half-width being smaller than said second width.

3. A magnetic linear propulsion system according to claim 1, wherein said first half-width is approximately half said second width.

4. A magnetic linear propulsion system according to claim 1, wherein said guideway coils are discrete and spaced apart from each other.

5. A magnetic linear propulsion system according to claim 1, wherein said guideway coils are continuous.

6. A magnetic linear propulsion system according to claim 1, wherein said guideway coils are continuous and provided in a ladder and rung configuration.

7. A magnetic linear propulsion system according to claim 5, wherein said guideway coils are overlapping.

8. A magnetic linear propulsion system according to claim 5, wherein said null flux excitation PLIM coil has a first half-width and said guideway coil has a second width, said first half-width being approximately half said second width.

9. A magnetic linear propulsion system according to claim 7, wherein said null flux excitation PLIM coil has a first half-width and said guideway coil has a second width, said first half-width being approximately one-quarter said second width.

10. A magnetic linear propulsion system according to claim 1, wherein said null flux excitation PLIM coil has a substantially figure-8 geometry.

11. A magnetic linear propulsion system according to claim 10, wherein said null flux excitation PLIM coil further comprises at least one steel lamination around which said figure-8 geometry is wound for enhanced flux path.

12. A magnetic linear propulsion system according to claim 1, wherein each of said plurality of pulses provided by said excitation circuit is substantially shorter than said active excitation window.

13. A magnetic linear propulsion system according to claim 12, wherein when said excitation circuit alters a number of said pulses provided to said null flux PLIM coil, an amount of thrust imparted to said vehicle is altered as well.

14. A magnetic linear propulsion system according to claim 12, wherein plurality of pulses are concentrated in a central portion of said active excitation window.

15. A magnetic linear propulsion system according to claim 1, wherein said excitation circuit further comprises capacitor means in resonant discharge for delivering a full sinusoidal wave pulse into said null flux excitation PLIM coil.

16. A magnetic linear propulsion system according to claim 15, wherein a time constant of said capacitor means is fixed greater than a desired maximum speed of the vehicle.

17. A magnetic linear propulsion system according to claim 16, wherein said time constant is greater than three times said desired maximum speed of said vehicle.

18. A magnetic linear propulsion system according to claim 1, wherein said excitation circuit further comprises at least one of an integrated gate controlled thyristor and an insulated gated bipolar thyristor.

19. A magnetic linear propulsion system comprising:
a plurality of guideway coils disposed on a guideway;
at least one excitation PLIM coil disposed on a vehicle operating along said guideway in communication with said guideway coils; and
at least one excitation circuit, in electrical communication with said excitation PLIM coil, forcing a plurality of pulses of current through said excitation PLIM coil during each active excitation window.

20. A magnetic linear propulsion system according to claim 19, wherein said excitation PLIM coil has a first half-width and said guideway coil has a second width, said first half-width being smaller than said second width.

21. A magnetic linear propulsion system according to claim 19, wherein said first half-width is approximately half said second width.

22. A magnetic linear propulsion system according to claim 19, wherein said guideway coils are discrete and spaced apart from each other.

23. A magnetic linear propulsion system according to claim 19, wherein said guideway coils are continuous.

24. A magnetic linear propulsion system according to claim 19, wherein said guideway coils are continuous and provided in a ladder and rung configuration.

25. A magnetic linear propulsion system according to claim 23, wherein said guideway coils are overlapping.

26. A magnetic linear propulsion system according to claim 23, wherein said excitation PLIM coil has a first half-width and said guideway coil has a second width, said first half-width being approximately half said second width.

27. A magnetic linear propulsion system according to claim 26, wherein said excitation PLIM coil has a first half-width and said guideway coil has a second width, said first half-width being approximately one-quarter said second width.

28. A magnetic linear propulsion system according to claim 19, wherein each of said plurality of pulses provided by said excitation circuit is substantially shorter than said active excitation window.

29. A magnetic linear propulsion system according to claim 28, wherein altering a number of said pulses provided to said PLIM coil by said excitation circuit alters an amount of thrust imparted to said vehicle.

30. A magnetic linear propulsion system according to claim 28, wherein plurality of pulses are concentrated in a central portion of said active excitation window.

31. A magnetic linear propulsion system according to claim 19, wherein said excitation circuit further comprises capacitor means in resonant discharge for delivering a full sinusoidal wave pulse into said excitation PLIM coil.

32. A magnetic linear propulsion system according to claim 31, wherein a time constant of said capacitance means is fixed greater than a desired maximum speed of the vehicle.

33. A magnetic linear propulsion system according to claim 32, wherein said time constant is greater than three times said desired maximum speed of said vehicle.

34. A magnetic linear propulsion system according to claim 19, wherein said excitation circuit further comprises at least one of an integrated gate controlled thyristor and an insulated gated bipolar thyristor.

35. A magnetic linear propulsion system comprising:
null flux coil means for propelling a vehicle;
guideway means for guiding said vehicle;
guideway coil means disposed on said guideway means for receiving induced current from said null flux coil means; and
excitation means for forcing a plurality of pulses of current through said null flux coil means during each active excitation window,
wherein when said pulses are forced through said null flux coil means, a current is induced in said guideway coil means, said guideway coil means current repelling said pulsed current in said null flux coil means to thereby propel said vehicle.

36. A method for controlling a magnetic linear propulsion system having a plurality of guideway coils disposed on a guideway, at least one null flux excitation PLIM coil disposed on a vehicle operating along the guideway in communication with the guideway coils, and at least one excitation circuit in electrical communication with the null flux excitation PLIM coil said method comprising the step of:
firing a plurality of pulses of current through the null flux excitation PLIM coil during each active excitation window.

37. A method for controlling a magnetic linear propulsion system according to claim 36, further comprising the step of:
controlling a speed of the vehicle be varying the number of pulses fired during the active excitation window.

38. A method for controlling a magnetic linear propulsion system according to claim 36, further comprising the step of:
concentrating the pulses fired into a central portion of the active excitation window.

39. A method for controlling a magnetic linear propulsion system according to claim 36, wherein said firing step further comprises the step of providing full sinusoidal wave pulses into the PLIM coil.
